(19) United States
(12) Patent Application Publication
(10) Pub. No.: US 2009/0083055 A1
(43) Pub. Date: Mar. 26, 2009

(54) Method and system for a scratchcard

(76) Inventor: Edwin Tan, New York, NY (US)

Correspondence Address: PERKINS COIE LLP, P.O. BOX 1208, SEATTLE, WA, 98111-1208, US

(21) Appl. No.: 11/903,227

(22) Filed: Sep. 20, 2007

(51) Int. Cl. G06Q 30/00; G06Q 99/00

(52) U.S. Cl. 705/1

(57) ABSTRACT

A method and a system are provided for providing online services associated with a scratchcard, such as domain name registration, online storage and Internet hosting. The method includes providing the scratchcard to a user, the scratchcard including a non-visible portion displaying an identifier. The method includes, responsive to a user request, verifying the identifier as valid. The method includes registering a domain name for the user if the identifier is verified as valid.

### BACKGROUND

The Internet identifies accessible computers through IP addresses, which are typically sequences of numbers. The Domain Name System (DNS) helps users by associating IP addresses with domain names. Domain names are strings of characters (for example, letters and numbers) which are easier for users to remember.

Domain names are typically maintained in a central directory called a registry. A domain name is registered when an entry is inserted into the directory of all the domain names and their corresponding computers on the Internet. Domain names ending with .aero, .biz, .com, .coop, .info, .museum, .name, .net, .org, or .pro can be registered through many different companies (known as “registrars”). The registrar will request various contact and technical information that make up the registration. The registrar will keep records of the contact information and submit the technical information to the registry.

Users may access a registrar's website, provide the required contact and technical information, and pay the registrar with a credit card.

A file hosting service or online file storage service is an Internet hosting service designed to host digital content, typically large files that are not web pages. The host may allow web and FTP access. Related services include video sharing, virtual storage and remote backup.

An Internet hosting service provides hosting services over the Internet. For example, hosting services may include:

A) full-featured hosting services such as virtual private server(s)/virtual dedicated server(s), dedicated hosting service(s)/dedicated server(s)/managed hosting service(s), and co-location services,

B) Internet hosting services including free hosting, shared Internet hosting service(s)/virtual hosting service(s), clustered hosting and reseller hosting

C) application-specific hosting including blog hosting, game guild/clan hosting, image hosting, video hosting, collaboration hosting and database hosting. also includes the hosting of any other proprietary services such as server-based office suites, instant messaging, file servers, etc.

D) file hosting services, online file storage and online media storage

E) remote/online/managed/unmanaged backup service(s)

F) game server hosting

G) DNS hosting

H) e-mail hosting

I) suites/combinations of any of or all of the above, for example, Google Apps/Microsoft Office Live/other similar applications.

J) credit for online advertising services (e.g. Google AdWords)

K) credit for internet virtual worlds

L) any other internet hosting service that may come into availability at later points of time This will require updates to the detailed description of the example embodiments.

### BRIEF DESCRIPTION OF THE DRAWINGS

FIG. 1 illustrates an example scratchcard.

FIG. 2A illustrates an example system for providing domain name registration associated with a scratchcard.

FIG. 2B illustrates an example system for providing online storage associated with a scratchcard.

FIG. 3 illustrates an example procedure for providing domain name registration associated with a scratchcard.

FIG. 4A illustrates an example metadata data structure.

FIG. 4B illustrates an example metadata data structure entry.

### DETAILED DESCRIPTION OF EXAMPLE EMBODIMENTS

The present invention provides systems and methods for using scratchcards associated with various services. For example, a scratchcard in association with domain name registration may be provided to a user. The scratchcard may be a prepaid card, where a user pays for and receives a scratchcard and, at a later time, verifies an identifier on the scratchcard before registering a domain name through a server. For example, the scratchcards may be ideal gifts, because they do not contain and are not associated with the purchaser's personal information. Other online services may be associated with the scratchcard instead of domain name registration, such as online storage or Internet hosting, or renewal of an existing online service.

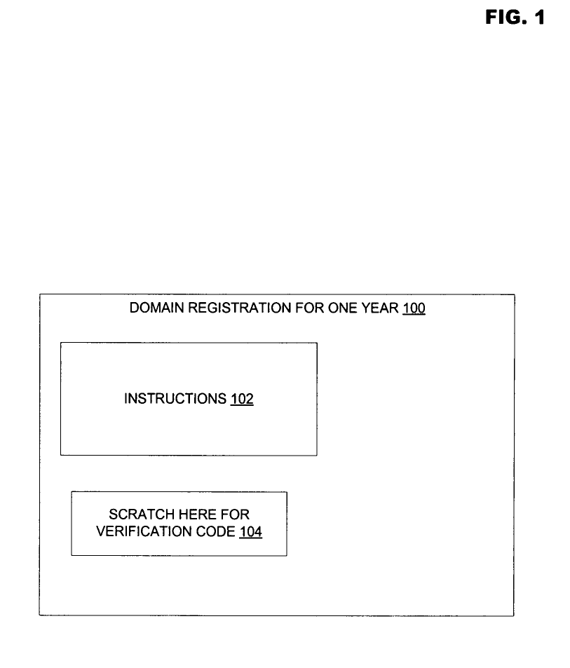

FIG. 1 illustrates an example scratchcard. A scratchcard 100 (also called a scratch off, scratch ticket, scratcher, scratchie, scratch-it, scratch game, or instant game) is a small token, usually made of cardboard or plastic, where one or more areas 104 contain concealed information. The area 104 may be covered by an opaque substance such as latex that cannot be seen through, but can be scratched off or otherwise removable. Alternatively, the area 104 may be covered with a peel-off strip configured to be peeled off by the user. Alternative coverings that are easily removed by the user may also be used. The scratchcard 100 may be in the shape and weight of a credit card. The scratchcard 100 may include instructions 102, graphics, or other text. The scratchcard 100 may be individually packaged in transparent plastic.

An alternative embodiment of the scratchcard 100 may be a compact disk (“CD”) business card. Small, rectangular CDs resembling a business card with silkscreen or offset printing are known. The CD business card may include software used as a one-time enabler in place of the concealed information discussed above. The CD business card may be dispensed in a similar manner to the scratchcard 100 as discussed.

A kiosk may store a collection of blank CD business cards, and burn appropriate software onto a CD business card when an online service is purchased. In this way, the software may function as a verification key or identifier in providing the online service. The kiosk may also print graphics onto the CD business card, for example, depicting what online service was purchased. Alternatively, the software may be pre-burned onto the CD business cards.

The CD business card may be used by a user at a terminal with a CD drive or reader, and the software included on the CD business card may function similarly to the concealed information, providing verification to a server that the CD business card is valid and the service with which the user is entitled, as described below.

An alternative embodiment of the CD business card may include concealed information as discussed above, and include software for use in connection with the purchased service. For example, if the service is Internet hosting, the software may include web page design software. If the service is online storage, the software may include communication applications to provide easy upload and download from the online storage account. If the service is domain name registration, the software may include forms and wizards to automate the registration process.

It will be appreciated that the above embodiments may be implemented with any other magnetic, optic, or electronic media configured to carry a one-time enabler software. Example media include regular compact disks, DVDs, Blu-ray, HD-DVD, flash memory, etc.

In an alternative embodiment, the scratchcard may be customized at the point of purchase, such as a kiosk, vending machine, online store, brick-and-mortar store, etc. This includes the selection of an unregistered domain name, the immediate registration of (and payment for) that domain name, the customization of the card face from provided templates or a design provided by the end user, the printing or minting of the card face (including the expiry date of the domain name) and the delivery of the card to the user. The newly registered domain name may be printed on the card face. These features may make the scratchcard more appropriate as a gift.

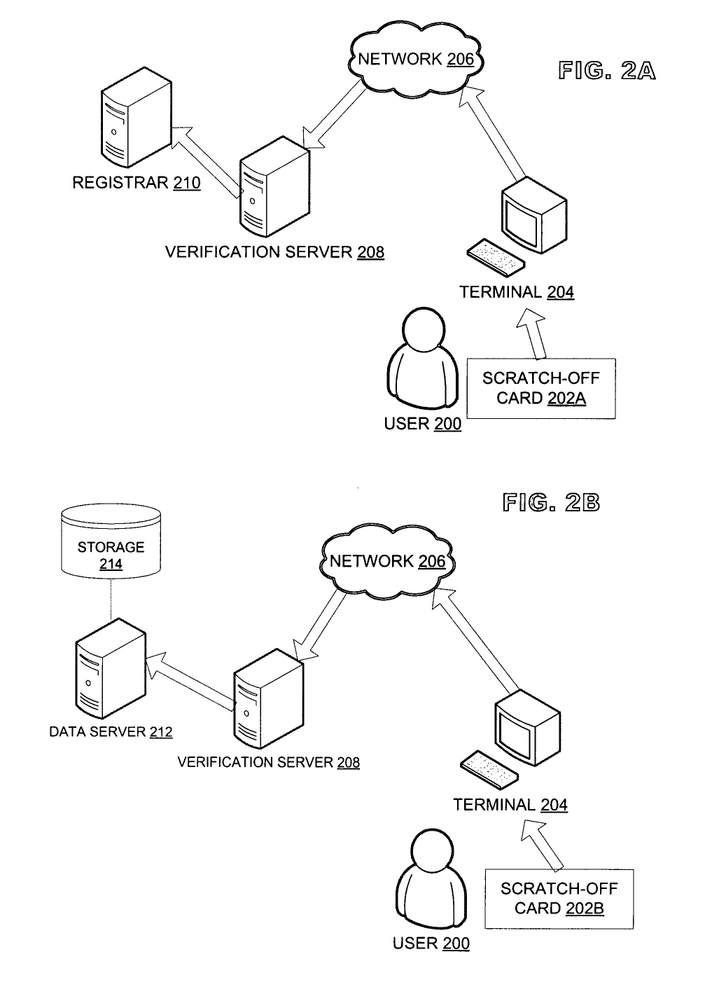

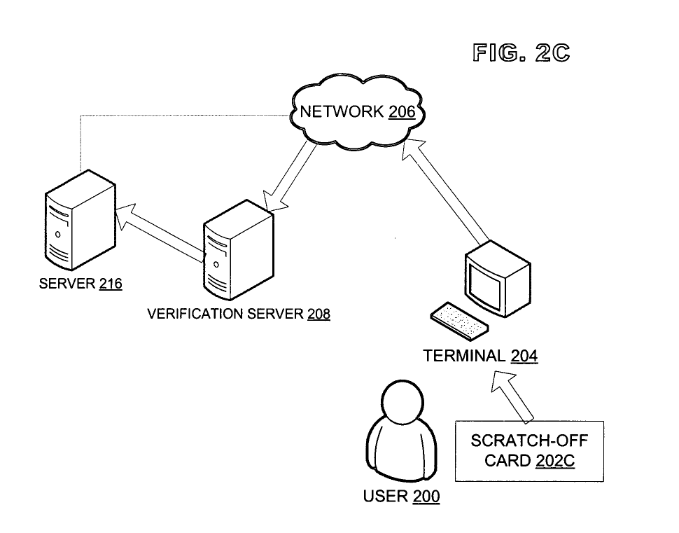

FIG. 2A illustrates an example system for providing domain name registration associated with a scratchcard. The scratchcard may be as depicted in FIG. 1. A user 200 may obtain a scratchcard 202A from a retail store (for example, a convenience store, an electronics store, a department store, etc.), an automated kiosk or vending machine, or another distribution site. The scratch card 202A may be provided to the user in exchange for currency or other consideration, or may be cards obtained at no cost to the user.

The user 200 may scratch off or at least partially remove a covered area of the scratchcard 202A to reveal an identifier associated with the scratchcard. For example, the identifier may be a globally unique identifier or some other identifier. The identifier may be associated with various metadata within the system, as described below. The user 200 may access a verification server 208 from a terminal 204 over the network 206. In one embodiment, the identifier may be the verification code provided with the scratchcard 202A.

The terminal 204 may be any computing device accessible to the user 200 and configured to communicate over the network 206. For example, the terminal 204 may be a personal computer, a wireless PDA device, a cellular phone, etc.

The network 206 may be configured to carry digital information between the terminal 204 and the verification server 208. For example, the network 206 may be the Internet.

The verification server 208 may be configured to verify the identifier of the scratchcard 202A, as described below.

The verification server 208 may be in communication with a registrar 210. The registrar 210 may communicate with the user 200 to obtain necessary information and register a domain name on behalf of the user based on the information.

As part of the verification process, the user 200 may have been provided with a security code provided on a receipt generated at the point-of-sale of the scratchcard 202A. The user 200 may be further required to input the security code into the terminal 204.

In an alternative embodiment, the registrar 210 may be combined with the verification server 208 in one server. Alternatively, they may be geographically dispersed.

In another embodiment, the registrar 210 may register domain names in a proprietary domain registrar that allows for the registration of domain names that are only accessible when third party software is installed into a web browser. For example, the registrar 210 may register a domain name with a private domain registrar such as www.3721.com, which allows users to register Chinese domain names.

In an example embodiment, the terminal 204 may be a telephone, the network 206 may be a telecommunication network, and the verification server 208 may be configured to interact with user 200 with voice prompts, receive voice commands and touch tone inputs.

FIG. 2B illustrates an example system for providing online storage associated with a scratchcard. The system may be similar to the system depicted in FIG. 2A. A scratchcard 202B may be as depicted in FIG. 1, and include an identifier.

The verification server 208 may be in communication with a data server 212. The data server 210 may communicate with the user 200 and provide an online storage account. The storage account may be stored in storage 214, wherein storage 214 is accessible to the data server 212.

The storage 214 may be a rewritable storage medium, such as a hard drive or a RAID array. The storage 214 may be proximal to the data server 212, or located in a geographically distant location. The storage 214 may communicate with the data server 212 over a network, such as a private network.

FIG. 2C illustrates an example system for providing Internet hosting associated with a scratchcard. The system may be similar to the system depicted in FIG. 2A. A scratchcard 202C may be as depicted in FIG. 1, and include an identifier.

The verification server 208 may be in communication with a server 216. The server 216 may provide Internet hosting services to the user 200. Internet hosting, for example, provides user web pages to computers via the network 206.

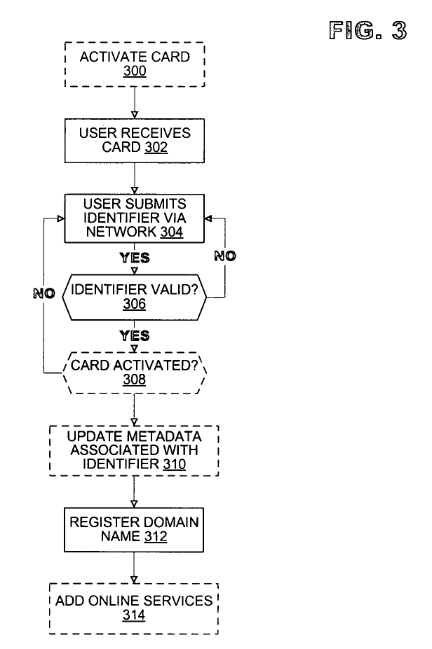

FIG. 3 illustrates an example procedure for providing domain name registration associated with a scratchcard. The procedure may execute in a system as illustrated in FIG. 2A. A server may be in communication with a network, and at least one scratchcard is available to a user. The scratchcard may be as depicted in FIG. 1 and include an identifier.

In 300, the scratchcard may optionally be activated. The server may store the activation of the scratchcard on an accessible storage. The activation step may be a security procedure to prevent theft of scratchcards.

The activation may occur at any point before the user receives the scratchcard. For example, the scratchcard may be sold from a retail location, such as a convenience store, and scanned at the point-of-sale when the scratchcard is sold to a user. An employee of the convenience store may scan the scratchcard and the identifier of the scratchcard may be transmitted to a central server. The server may record the activation of the scratchcard in an associated database entry. Thus, when the scratchcard is used, as discussed later, the server may allow the user by the user. If the scratchcard was not activated prior to an attempted use by a user, the server may deny the use and refuse to perform the service, such as registering an online domain name.

In 302, the user receives the scratchcard. The user may receive the scratchcard in return for paying currency or another consideration. Alternatively, the user may receive the scratchcard at no cost, for example, in a corporate promotion.

In 304, the user submits the identifier to the server via a terminal over a network, as described above. In one embodiment, one user may access the server from his home computer and enter the identifier found on the scratchcard.

In 306, the server may test whether the identifier is valid. The identifier may be checked against a list of valid identifiers accessible to the server. For example, the list of valid identifiers may be stored on the accessible storage.

In 308, the server may optionally test whether the scratchcard was activated in 300. For example, the server may check that the activation of the scratchcard has been stored on the accessible storage.

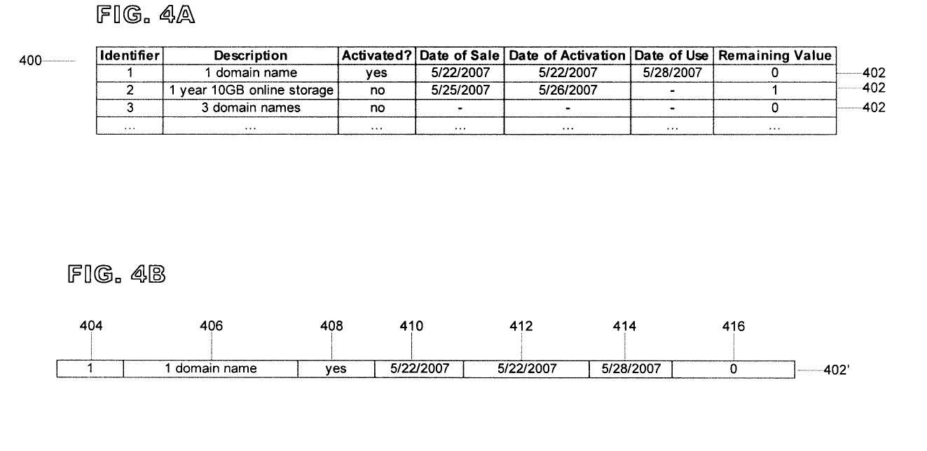

In 310, the server may optionally update metadata associated with the identifier. Metadata may be associated with the identifier, as described in FIG. 4. Such metadata may be updated when a scratchcard is used by the user.

In 312, the server registers a requested domain name for the user. In response to server prompts, the user enters necessary information to register the domain name. With this information, the server registers the domain name.

The necessary information may be, for example, a requested domain name, contact information and address, and any other information necessary by the registrar to register the domain name. Other information may be requested. The necessary information may be transmitted to the server via network from a terminal accessible to the user.

It will be appreciated that the domain name to be registered may have one of the many currently existing top-level domains (TLD), or any TLD developed in the future. A TLD may be classified as a country code TLD (ccTLD), generic TLD (gTLD), or infrastructure TLD (iTLD). The domain name may also be registered with an alternative DNS root, for example, those found in private intranets and wide-area networks. The domain name may also be registered through a service, such as http://www.3721.com/for Chinese domain names. The domain name may include an internationalized domain name (IDN) that potentially contains non-ASCII characters.

In one embodiment, the server may execute the registration itself. In another embodiment, the server may cause a separate registrar to register the requested domain name.

It will be appreciated the above procedure can easily be modified to provide other services to the user. Step 312 may be replaced to provide the desired service.

In 314, the server may add additional online services for the user. For example, the user may purchase additional online services with a credit card, the same scratchcard received in 302 (if the scratchcard is a multi-use scratchcard), a different scratchcard, or any other form of payment.

The online services added in 314 may be the same service provided in 312, or any other online service or renewal of an online service. The online services may be added at any time after 312. For example, 314 may occur in the same session as 312, or in a subsequent session.

In an example embodiment of the present invention, the scratch card may be marketed as a service that enables a user to use domains with services such as Google Apps or Microsoft Office Live, or other application suites that contain combinations of specific Internet-hosted applications.

FIG. 4A illustrates an example metadata data structure. The metadata described above may be stored in the metadata data structure 400 on a storage medium accessible to a server. The metadata data structure 400 may include a set of records 402, each record 402 representing a scratchcard.

It will be appreciated that the metadata data structure 400 may be stored in a variety of ways. For example, it may be stored as a tab delimited or comma delimited flat file, in a relational database or another storage method accessible to a server. The metadata data structure 400 may be used for accounting, auditing, or fraud-detection purposes.

FIG. 4B illustrates an example metadata data structure entry. Each entry may be a record 402′. Each record 402′ may contain a variety of metadata, such as an identifier 404. For example, each scratchcard may be associated with an identifier. The identifier may be an alpha-numeric sequence of characters and used to differentiate one scratchcard from another by the server.

The record 402′ may also include a description 406. Description 406 may be a text description of the scratchcard.

The record 402′ may also include an activation field 408. As described above, a scratchcard may be activated at a point of sale when purchased by a user, as a security measure. The activation may be recorded in field 408.

The record 402′ may also include a date of sale 410. The date of sale 410 may record a date of sale of the scratchcard. For example, scratchcards may have an expiry date from the date of sale.

The record 402′ may also include a date of activation 412. The date of activation 412 may record a date of activation of the scratchcard. For example, scratchcards may have an expiration date, for example, it may expire after a certain period of time from the date of activation.

The record 402′ may also include a date of use 414. The date of use 414 may record one or more dates on which the scratchcard was use. For a one-use scratchcard, such as a one-use domain name registration scratchcard, there may be only one date in date of use 414. For multi-use scratchcards, date of use 414 may include a set of dates.

The record 402′ may also include a remaining value 416. The remaining value 416 may record a number of remaining uses left on the scratchcard. For a one-use scratchcard, such as a one-use domain name registration scratchcard, the remaining value 416 may decrement to zero after the first use. For multi-use scratchcards, this field may track remaining value on the scratchcard.

It will be appreciated that any amount and type of metadata may be associated with each card.

It will be appreciated that the scratchcards may be sold in packages. For example, packages of multiple scratchcards associated with domain name registration. Alternatively, each package may contain a plurality of types of scratchcards, each type of scratchcard associated with one online service. It will be appreciated that the scratchcards may be sold together with a display case.

It will be appreciated that the identifier may be provided to the user in a variety of other media. For example, the identifier may be printed on a card and enclosed in a box or other packaging. For example, the identifier may be printed on a gift certificate. For example, the identifier may be sent to the user in an email.

In an example embodiment where the identifier is printed on a gift certificate, a user may purchase the gift certificate from a retail store, receive the gift certificate in the mail or otherwise receive the gift certificate. Security measures may be utilized on the gift certificate to ensure only the user may read the identifier. The gift certificate may be purchased by the user and provided to a second user as a gift. The identifier may then be used in a system similar to those depicted in FIGS. 2A and 2B.

In an example embodiment where the identifier is provided in an email, the user may receive the email after an online purchase. The email may be sent to an email address provided by the user during the purchase process. Alternatively, the email may be received as a promotional item from another party. Alternatively, the email may be received as a gift, where the gift was purchased by a second user. The identifier may then be used in a system similar to those depicted in FIGS. 2A and 2B.

An example embodiment of the present invention may be a device for registering a domain name. The device may include a scratchcard including an identifier concealed by an opaque substance, the identifier being adapted for a system for registering domain names, the opaque substance being adapted for at least partial removal from the card in order to expose the identifier to a user. The opaque substance may include latex and be configured to adhere to the scratchcard. The opaque substance may be removed by scratching. The scratchcard may be packaged to be dispensed from an automated kiosk. The device may be dispensed from the automated kiosk after being activated.

Another example embodiment of the present invention may be a method of making a scratchcard for providing online storage. The method may include providing a scratchcard with an identifier to a user, the identifier adapted for a system for providing online storage. The method may include concealing the identifier on the scratchcard with an opaque substance, the opaque substance being adapted to be partially removed by the user in order to reveal the identifier. The opaque substance may include latex and be configured to adhere to the scratchcard. The opaque substance may be removed by scratching. The scratchcard may be packaged to be dispensed from an automated kiosk. The scratchcard may be dispensed from the automated kiosk after being activated.

Another example embodiment of the present invention may be a system for providing online storage. The system may include a user interface adapted to receive an identifier from a user, the identifier being adapted for the system for providing online storage and being carried on a scratchcard, the identifier being initially concealed on the scratchcard with an opaque substance, and being revealed to the user after the opaque substance is at least partially removed. The system may include a validation component adapted to validate the received identifier. The system may include a medium accessible to the validation component, the medium including a set of valid identifiers and metadata associated with each identifier. The opaque substance may include latex and be configured to adhere to the scratchcard. The opaque substance may be removed by scratching. The scratchcard may be packaged to be dispensed from an automated kiosk.

Another example embodiment of the present invention may be a method for enabling a user to providing Internet hosting. The method may include providing a scratchcard to the user, the scratchcard carrying an identifier concealed by an at least partially removable opaque substance, the identifier being adapted for a system for providing Internet hosting. The method may include activating the scratchcard responsive to a user purchase of the scratchcard. The method may include, before providing Internet hosting, further verifying the scratchcard has been activated. The scratchcard may be provided to the user in exchange for currency. The scratchcard may be packaged to be dispensed from an automated kiosk. The scratchcard may be dispensed from the automated kiosk after being activated.

Another example embodiment of the present invention may be a system for registering a domain name. The system may include a user interface adapted to receive an identifier from a user terminal, the identifier being adapted for the system for registering domain names and being included on a computer-readable medium. The system may include a validation component adapted to validate the received identifier. The system may include a registration component adapted to register a requested domain name if the identifier is valid. The system may include a storage accessible to the validation component, the storage including a set of valid identifiers and metadata associated with each identifier. The user interface may communicate with the user terminal over the Internet. The computer-readable medium may be dispensed to a user from an automated kiosk in exchange for currency. The computer-readable medium may be dispensed to the user after being activated.

Although the preceding text sets forth a detailed description of various embodiments, it should be understood that the legal scope of the invention is defined by the words of the claims set forth below. The detailed description is to be construed as exemplary only and does not describe every possible embodiment of the invention. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A device for registering a domain name, comprising:
a scratchcard including an identifier concealed by an opaque substance, the identifier being adapted for a system for registering domain names, the opaque substance being adapted for at least partial removal from the card in order to expose the identifier to a user.

2. The device of claim 1, wherein the opaque substance includes latex and is configured to adhere to the scratchcard.

3. The device of claim 1, wherein the opaque substance is removed by scratching.

4. The device of claim 1, wherein the scratchcard is packaged to be dispensed from an automated kiosk.

5. The device of claim 4, wherein the device is dispensed from the automated kiosk after being activated.

6. A method of making a scratchcard for providing online storage, comprising:
providing a scratchcard with an identifier to a user, the identifier adapted for a system for providing online storage; and
concealing the identifier on the scratchcard with an opaque substance, the opaque substance being adapted to be partially removed by the user in order to reveal the identifier.

7. The method of claim 6, wherein the opaque substance includes latex and is configured to adhere to the scratchcard.

8. The method of claim 6, wherein the opaque substance is removed by scratching.

9. The method of claim 6, wherein the scratchcard is packaged to be dispensed from an automated kiosk.

10. The method of claim 9, wherein the scratchcard is dispensed from the automated kiosk after being activated.

11. A system for providing online storage, comprising:
a user interface adapted to receive an identifier from a user, the identifier being adapted for the system for providing online storage and being carried on a scratchcard, the identifier being initially concealed on the scratchcard with an opaque substance, and being revealed to the user after the opaque substance is at least partially removed;
a validation component adapted to validate the received identifier; and
an accessible memory for storing files responsive to user requests.

12. The system of claim 11, further comprising:
a medium accessible to the validation component, the medium including a set of valid identifiers and metadata associated with each identifier.

13. The system of claim 11, wherein the opaque substance includes latex and is configured to adhere to the scratchcard.

14. The system of claim 11, wherein the opaque substance is removed by scratching.

15. The system of claim 11, wherein the scratchcard is packaged to be dispensed from an automated kiosk.

16. A method for enabling a user to providing Internet hosting, comprising:
providing a scratchcard to the user, the scratchcard carrying an identifier concealed by an at least partially removable opaque substance, the identifier being adapted for a system for providing Internet hosting.

17. The method of claim 16, further comprising:
activating the scratchcard responsive to a user purchase of the scratchcard; and
before providing Internet hosting, further verifying the scratchcard has been activated.

18. The method of claim 16, wherein the scratchcard is provided to the user in exchange for currency.

19. The method of claim 16, wherein the scratchcard is packaged to be dispensed from an automated kiosk.

20. The method of claim 19, wherein the scratchcard is dispensed from the automated kiosk after being activated.

21. A system for registering a domain name, comprising:
a user interface adapted to receive an identifier from a user terminal, the identifier being adapted for the system for registering domain names and being included on a computer-readable medium;
a validation component adapted to validate the received identifier; and
a registration component adapted to register a requested domain name if the identifier is valid.

22. The system of claim 21, further comprising:
a storage accessible to the validation component, the storage including a set of valid identifiers and metadata associated with each identifier.

23. The system of claim 21, wherein the user interface communicates with the user terminal over the Internet.

24. The system of claim 21, wherein the computer-readable medium is dispensed to a user from an automated kiosk in exchange for currency.

25. The system of claim 24, wherein the computer-readable medium is dispensed to the user after being activated.

26. A method for enabling a user to register a domain name, comprising:
providing a scratchcard to the user, the scratchcard carrying an identifier concealed by a removeable opaque substance, the identifier being adapted for a system for registering domain names.

27. The method of claim 26, further comprising:
activating the scratchcard responsive to a user purchase of the scratchcard; and
before registering the domain name, further verifying the scratchcard has been activated.

28. The method of claim 26, wherein the scratchcard is packaged to be dispensed from an automated kiosk.

29. The method of claim 26, wherein the scratchcard is provided to the user in exchange for currency.

30. A method for registering a domain name, comprising:
receiving an identifier from a user, the identifier being adapted to a system for registering domain names and being carried on a scratchcard, the identifier being initially concealed on the scratchcard with an opaque substance, and being revealed to the user after the opaque substance is at least partially removed;
validating the identifier; and
if the identifier is valid, registering a domain name requested by the user.

31. The method of claim 30, wherein the identifier is received from the user over the Internet.

32. The method of claim 30, wherein the validating includes comparing the identifier to a set of valid identifiers.

33. A system for registering a domain name, comprising:
a user interface adapted to receive an identifier from a user, the identifier being adapted for the system for registering domain names and being carried on a scratchcard, the identifier being initially concealed on the scratchcard with an opaque substance, and being revealed to the user after the opaque substance is at least partially removed;
a validation component adapted to validate the received identifier; and
a registration component adapted to register a requested domain name if the identifier is valid.

34. The system of claim 33, further comprising:
a medium accessible to the validation component, the medium including a set of valid identifiers and metadata associated with each identifier, the validation component adapted to validate the received identifier against the set of valid identifiers.

35. A method for registering a domain name, comprising:
receiving a scratchcard, the scratchcard carrying an identifier concealed on scratchcard with an opaque substance;
at least partially removing the opaque substance to reveal the identifier;
providing the identifier to a domain name registration system; and
providing a requested domain name to the domain name registration system;
wherein the domain name is requested by the domain name registration system if the identifier is valid.

36. The method of claim 35, wherein the identifier and the requested domain name are provided over the Internet.

37. A device for providing online storage, comprising:
a scratchcard including an identifier concealed with an opaque substance, the identifier being adapted for a system for providing online storage to a user, the opaque substance being adapted for at least partial removal from the card in order to expose the identifier to the user.

38. The device of claim 37, wherein the opaque substance includes latex and is configured to adhere to the scratchcard.

39. The device of claim 37, wherein the scratchcard is packaged to be dispensed from an automated kiosk.

40. The device of claim 37, wherein the opaque substance is at least partially removed by scratching.

41. A method of enabling a user to receive online storage service, comprising:
providing a scratchcard to the user, the scratchcard carrying an identifier concealed by a removable opaque substance, the identifier being adapted for a system for providing online storage.

42. The method of claim 41, further comprising:
activating the scratchcard responsive to a user purchase of the scratchcard; and
before providing online storage, verifying that the scratchcard has been activated.

43. The method of claim 41, wherein the scratchcard is packaged to be dispensed from an automated kiosk.

44. The method of claim 41, wherein the scratchcard is provided to the user in exchange for currency.

45. A method for providing online storage, comprising:
receiving an identifier from a user, the identifier being adapted for a system for providing online storage and being carried on a scratchcard, the identifier being initially concealed on the scratchcard with an opaque substance, and being revealed to the user after the opaque substance is at least partially removed;
validating the identifier; and
if the identifier is valid, providing online storage to the user.

46. The method of claim 45, wherein the identifier is received from the user over the Internet.

47. The method of claim 45, wherein the validating includes comparing the identifier with a set of valid identifiers.

48. A system for providing Internet hosting, comprising:
a user interface adapted to receive an identifier from a user, the identifier being adapted for the system for providing Internet hosting and being carried on a scratchcard, the identifier being initially concealed on the scratchcard with an opaque substance, and being revealed to the user after the opaque substance is at least partially removed;
a validation component adapted to validate the received identifier; and
a registration component adapted to register a requested domain name if the identifier is valid.

49. The system of claim 48, further comprising:
a medium accessible to the validation component, the medium including a set of valid identifiers and metadata associated with each identifier.

50. A method for providing Internet hosting, comprising:
receiving a scratchcard, the scratchcard carrying an identifier concealed on the card with an opaque substance;
at least partially removing the opaque substance to reveal the identifier;
providing the identifier to an Internet hosting system; and
activating an Internet hosting account on the Internet hosting system; wherein the Internet hosting account is activated if the identifier is valid.

51. The method of claim 6, wherein the identifier is used by the system in providing online storage to a user
